(19) United States
(12) Patent Application Publication
(10) Pub. No.: US 2020/0258182 A1
(43) Pub. Date: Aug. 13, 2020

(54) ARTIFICIAL INTELLIGENCE TRACKING SYSTEM AND METHOD

(71) Applicant: TrekTech, Eugene, OR (US)

(72) Inventors: Andrew Bentley, Eugene, OR (US); Jessie Haynes, Ventura, CA (US)

(21) Appl. No.: 16/787,528

(22) Filed: Feb. 11, 2020

Related U.S. Application Data
(60) Provisional application No. 62/804,360, filed on Feb. 12, 2019.

(51) Int. Cl. G06Q 50/26; G06N 20/00; G06N 5/04; G06F 16/23; G06Q 10/10; G06Q 10/04; G08B 7/06; H04W 4/024; H04W 4/029

(52) U.S. Cl. CPC G06Q 50/265; G06N 20/00; G06N 5/04; G06F 16/2379; H04W 4/029; G06Q 10/047; G08B 7/066; H04W 4/024; G06Q 10/1093

(57) ABSTRACT

A method of intelligent tracking and analysis of assets enables a user to track and analyze the position and behavioral movement pattern of an asset in a service area, confined in a geofence. A tracking tag detects and communicates the position of the asset in the service area. An artificial intelligence software analyzes the locations of the asset to generate aggregate data representing the locations of the asset; and then synthesizes the data to create a behavioral movement pattern of the asset. The artificial intelligence software prompts the user to navigate the service area to access the asset, or an area related to the asset. The user sets up an event indicative of the behavioral movement pattern of the asset. An alert transmits to user when the event occurs. For example, a movement pattern indicative of an emergency situation alerts an administrator or public safety official to investigate.

### CROSS REFERENCE OF RELATED APPLICATIONS

This application claims the benefits of U.S. provisional application No. 62/804,360, filed Feb. 12, 2019 and entitled ARTIFICIAL INTELLIGENCE TRACKING SYSTEM AND METHOD, which provisional application is incorporated by reference herein in its entirety.

### FIELD OF THE INVENTION

The present invention relates generally to a method of intelligent tracking and analysis of assets enables a user to track and analyze the position and behavioral movement pattern of an asset in a service area, confined in a geofence. A tracking tag detects and communicates the position of the asset in the service area. An artificial intelligence software analyzes the locations of the asset to generate aggregate data representing the locations of the asset; and then synthesizes the data to create a behavioral movement pattern of the asset. The artificial intelligence software prompts the user to navigate the service area to access the asset, or an area related to the asset. The user sets up an event indicative of the behavioral movement pattern of the asset. An alert transmits to user when the event occurs. For example, a movement pattern indicative of an emergency situation alerts an administrator or public safety official to investigate.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, detecting and monitoring the movement of valuable assets, people, and resources in real time over a wide area with little direct human supervision is costly and has limited efficacy. Thus, it is known in the art that tracking systems can be useful for monitoring valuable assets, people, and resources by determining their location, often in real-time. One example is a GPS tracking system that can be placed in a vehicle, on a cell phone, or on special GPS devices, which can either be a fixed or portable unit. Generally, the GPS works by providing information on exact location. It can also track the movement of a vehicle or person.

Often, the asset is tagged for identification, or if connected to a tracking system, for tracking the movement thereof. Such tracking technologies include passive, semi-passive, and active tags, which are placed on an item of property. These tags differ with respect to factors such as power usage and whether they merely reflect an incoming signal or actively transmit a signal. Passive tags are those that are queried by a radiated source, such as a scanner. Active tags are battery-based and radiate their own signals.

Other proposals have involved systems and methods for tracking assets and people in a closed service area. The problem with these gripping devices is that they do not allow for tracking tags to be affixed to the asset for monitoring the positions and movements of the asset. Also, artificial intelligence software is not utilized to synthesize aggregate data of the movements of the asset, so as to help the administrator navigate the service area, or assign an event. Even though the above cited systems and methods for tracking assets and people in a closed service area meet some of the needs of the market, a method of intelligent tracking and analysis of assets that enables a user to track and analyze the position and behavioral movement pattern of an asset in a service area, confined in a geofence, receive navigational prompts from artificial intelligence software, and assign events and alerts related to the position/movement of the asset in the service area, is still desired.

### SUMMARY

Illustrative embodiments of the disclosure are generally directed to a method of intelligent tracking and analysis of assets. The method of intelligent tracking and analysis of assets is configured to enable a user to track and analyze the position and behavioral movement pattern of at least one asset in a service area. A tracking tag detects and communicates the position of the asset in the service area, which is confined inside a geofence. An artificial intelligence software analyzes and synthesizes the locations of the asset to generate aggregate data representing the locations of the asset; and then synthesizes the data to create the behavioral movement pattern of the asset. The artificial intelligence software may then prompt the user to navigate the service area, within the geofence, to access the asset, or access an area related to the asset. The user may also set up at least one event that is indicative of the behavioral movement pattern of the asset. An alert transmits to the user when the event occurs. For example, a movement pattern indicative of an emergency situation alerts an administrator or public safety official. In essence, the system and method allow for geospatial, end-to-end aggregate movement data-processing, and visual relay display communications of an asset through use of a tracking tag and artificial intelligence software analyzing the position data generated by movements of the asset within the service area. The detection of the asset may be performed through frequency and artificial intelligence synthesizing frequency, so as to determine the type of asset. Thus, an asset tag is not required for tracking. It is just one possible embodiment of the method.

In one aspect, a method for intelligent tracking and analysis of assets, comprises an initial Step of affixing, by a user, a tracking tag to at least one asset, the tracking tag comprising a location determining component operable to track at least one position of the asset, the tracking tag further comprising a communications element coupled with the position determining component, the communications element operable to communicate the tracked position of the asset.

The method also includes a Step of tracking, through the location determining component, the at least one position of the asset in a service area, the service area being confined inside a geofence.

The method may further comprise a Step of generating aggregate data from the asset, the aggregate data being based on the at least one position of the asset.

In some embodiments, a Step comprises synthesizing the aggregate data with an artificial intelligence software.

A Step includes learning, by the artificial intelligence software, a behavioral movement pattern of the asset based on the at least one position of the asset.

In some embodiments, a Step may include prompting, by the artificial intelligence software, the user to navigate through the service area to access the asset, the prompting based on the synthesized aggregate data.

A Step comprises navigating, by the user, through the service area, the navigation based on the prompting by the artificial intelligence software.

The method may further comprise a Step of assigning at least one event, the event being indicative of the behavioral movement pattern of the asset. A final Step includes relaying an alert to the user during the event.

The method also includes the element of detecting devices without a tag. Thus, the user can detect and locate assets, such as electronic equipment and/or devices and components of those devices without the use of an asset tag, but rather by identifying and tracking an output signal generated by the asset. Thus, it is not necessary for the tag to be affixed to the asset in order to be tracked.

In another aspect, the user comprises an administrator, or a public safety official, or both.

In another aspect, the method also includes a step of comprising storing the aggregate data in a data storage unit.

In another aspect, the method also includes a step of communicating, by the communications element of the tracking tag, with a gateway.

In another aspect, the communications element of the tracking tag transmits the position of the user to the data storage unit through the gateway.

In another aspect, the method also includes a step of navigating an illuminated navigation path, by the user, through the service area, the navigation based on the prompting by the artificial intelligence software.

In another aspect, the asset includes at least one of the following: a device, a car, a bus, a truck, a forklift, a motorcycle, a bicycle, a scooter, a person, and an animal.

In another aspect, the method also includes a step of assigning, by the user, an event to the behavioral movement pattern of the asset.

In another aspect, the step of prompting the user to navigate through the service area, based on the synthesized aggregate data, further comprises alerting the user to a threat in the service area.

In another aspect, the method also includes a step of filing a report about the event with the administrator, the public safety official, or both.

In another aspect, the method also includes a step of marking the travel event on a calendar.

In another aspect, the event comprises a travel event.

In another aspect, the method also includes a step of triggering the alert to indicate the travel event to the user.

In another aspect, the method also includes a step of navigating, by the user, the service area to reach the travel event, whereby the synthesized aggregate data generates an optimal route to the travel event.

In another aspect, the method also includes a step of creating, by the user, at least one condition for the asset to navigate the service area, the condition being based on at least one of the following: the position of the asset in the service area, the behavioral movement pattern of the asset, a time period, and a distance between the asset and the user.

In another aspect, the method also includes a step of sharing, by the user, the position and the behavioral movement pattern of the asset in the service area.

In another aspect, the method also includes a step of generating feedback by the user, the feedback related to the position of the asset in the service area, and the behavioral movement pattern of the asset.

In another aspect, the method also includes a step of investigating, by the public safety official, the alerted event, whereby the location of the administrator in the service area is viewable by the public safety official.

One objective of the present invention is to track and analyze the position and behavioral movement pattern of at least one asset in a service area through use of a tracking tag and artificial intelligence software.

Another objective is to track and account for valuable assets within a service area and geofence.

Another objective is to provide accountability for both public and private spaces wherein people can feel safe and competent as they navigate the world around them.

Yet another objective is to provide the administrator and public safety official with informed positional data for navigating the service area to access the asset, or access a related place/function of the asset.

Yet another objective is to allow an administrator of a public and private space to make informed decisions based on aggregate and near real-time data.

Yet another objective is to allow the user to navigate through a service area and receive optimal routes and warnings after the aggregate data is synthesized by the artificial intelligence software in near real-time.

Yet another objective is to allow the user to generate a calendar having events.

Yet another objective is to allow a public safety official to receive an alert and a location of the user if an anomalous event occurs in the service area, so that the public safety official can render Aid to the user, including for user-designated events.

Yet another objective is to provide an easy to operate method of intelligent tracking and analysis of assets.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a flowchart of an exemplary method of intelligent tracking and analysis of assets, in accordance with an embodiment of the present invention; and

FIG. 2 illustrates a block diagram showing the components of the method of intelligent tracking and analysis of assets, in accordance with an embodiment of the present invention.

Like reference numerals refer to like parts throughout the various views of the drawings.

### DETAILED DESCRIPTION OF THE INVENTION

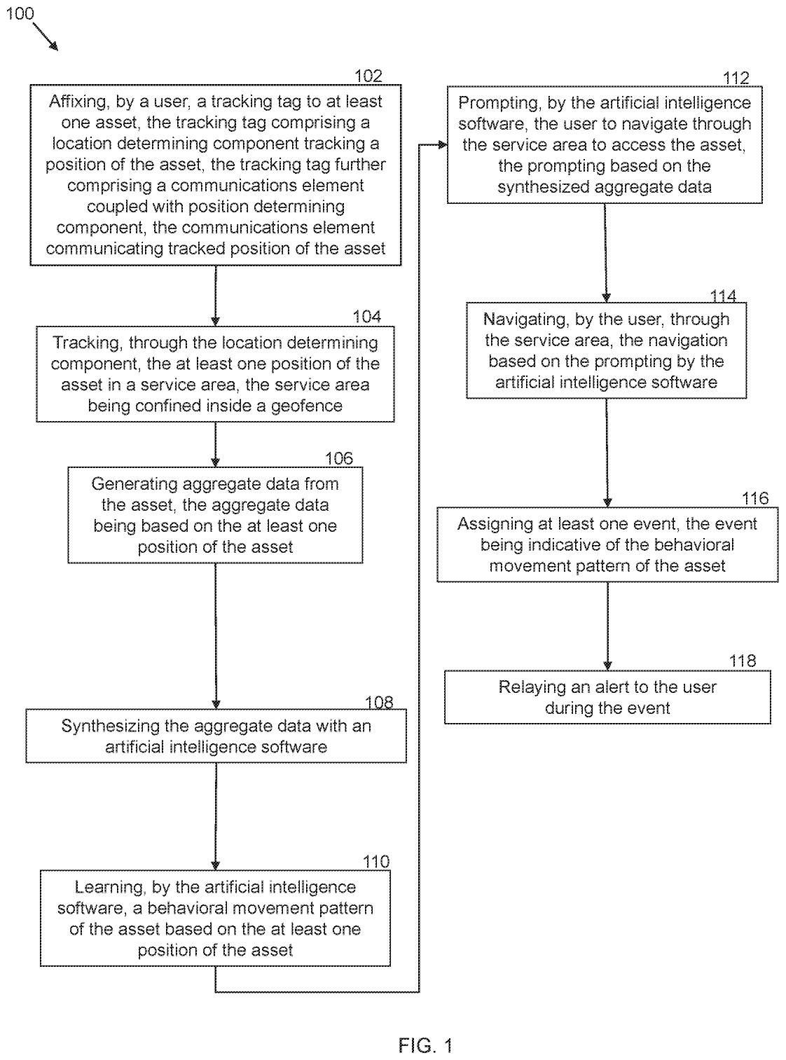

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

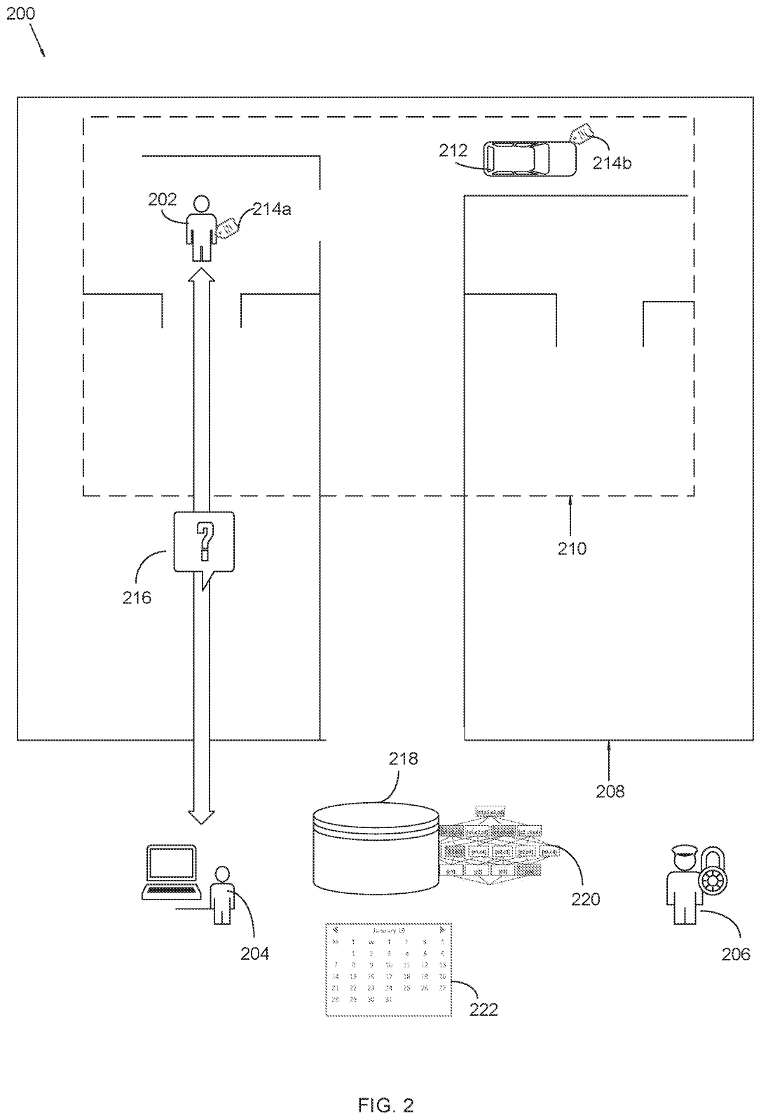

A method 100 of intelligent tracking and analysis of assets is referenced in FIGS. 1-2. As flowchart in FIG. 1 shows, the method 100 is configured to enable a user to track and analyze the position and behavioral movement pattern of at least one asset in a service area. A tracking tag detects and communicates the position of the asset in the service area, which is confined inside a geofence. An artificial intelligence software analyzes and synthesizes the locations of the asset to generate aggregate data representing the locations of the asset; and then synthesizes the data to create the behavioral movement pattern of the asset. The artificial intelligence software may then prompt the user to navigate the service area, within the geofence, to access the asset, or access an area related to the asset. The user may also set up at least one event that is indicative of the behavioral movement pattern of the asset. An alert transmits to the user when the event occurs. For example, a movement pattern indicative of an emergency situation alerts an administrator or public safety official. In essence, the system and method 100 allow for geospatial, end-to-end aggregate movement data-processing, and visual relay display communications of an asset through use of a tracking tag and artificial intelligence software analyzing the position data generated by movements of the asset within the service area.

The method 100 also includes the element of detecting devices without a tag. Thus, the user can detect and locate assets, such as electronic equipment and/or devices and components of those devices without the use of an asset tag, but rather by identifying and tracking an output signal generated by the asset. Thus, it is not necessary for the tag to be affixed to the asset in order to be tracked. Rather, the asset is tracked from output signals generated by the asset. If the asset is detected, identified and tracked, just like with the tagged assets, certain actions should be taken on it either determined by artificial intelligence (AI) or an administration, as described below. Thus, both the use of an asset tag and the ability of hardware to eventually (after training the AI), to detect electronic equipment without an asset tag is integral to the design of the marriage between hardware and software marriage.

In yet another alternative embodiment, the method enables the user to identify and track unique language output signals from the asset. The unique language output signal is generated by each type of asset, electronic device, and electronic equipment. The unique language of electronic signals is generated so that each signature signal from each kind of asset or device is unique enough to create this language. The asset is known by its unique language. In another embodiment, a certain unique language output signal to be detected with the technology can be added to a list of “words” or data sets pointing to what the asset/device either is, or what the asset/device could be. In this manner, the method allows the user to isolate what a specific piece of electronic equipment is and even accept a possibility of two or three maybe even four etc, things the electronic equipment could be. Those skilled in the art will recognize that with all of the hundreds of electronic devices in the world, the technology from the method would isolate the possibilities down to two or three types of assets/devices that a particular signal can represent.

In yet another possible embodiment of the present invention, shown in diagram 200 in FIG. 2, a user 202, such as an administrator 204 and a public safety official 206 to track, monitor, and make responsive decisions about movement of at least one asset 212 with the help of artificial intelligence software. The method 100 is configured to enable the user 202 and administrator 204 to affix a tracking tag 214a-b to at least one asset 212, or the user 202, or both.

In some embodiments, the tracking tag 214a-b communicates with a communication device to track the movement and behavior of the asset 212; and thereby generates aggregate data for the movement, location, and general behavioral patterns of the asset 212 and user 202. The aggregate data of the asset's movement is used by the user 202, administrator 204, and public safety official 206 to make correlative decisions in a service area 208, or a geofence 210 inside the area.

In some embodiments, an artificial intelligence software 220 is configured to synthesize the aggregate data, correctly interpret the aggregate data, to learn from the aggregate data. The artificial intelligence software 220 then uses those learnings to achieve specific goals and tasks for the user 202, administrator 204, and public safety official 206 through flexible adaptation of the aggregate data.

Specifically, the artificial intelligence software 220 learns the movement, location, and behavioral pattern of the asset 212 and user 202 in the service area 208. The artificial intelligence software 220 then works to process the aggregate data, so as to prompt optimal navigational routes for the user 202, detect anomalies and dangers in the movement and position of the asset 212 and user 202, and trigger travel events in the user's calendar 222. Furthermore, if the artificial intelligence software 220 detects a predetermined anomalous event occurring in the service area 208, an alert is relayed to the administrator 204 or a public safety official 206 to investigate and take appropriate actions.

FIG. 1 illustrates a flowchart diagram of an exemplary method 100 of intelligent tracking and analysis of assets. In one possible embodiment, the method 100 of intelligent tracking and analysis of assets, comprises an initial Step 102 of affixing, by a user 202, a tracking tag to at least one asset 212, the tracking tag comprising a location determining component operable to track at least one position of the asset 212, the tracking tag further comprising a communications element coupled with the position determining component, the communications element operable to communicate the tracked position of the asset 212. In some embodiments, the asset may include, without limitation, a car, a bus, a truck, a forklift, a motorcycle, a bicycle, a scooter, a person, and an animal. In other embodiments, the user 202 comprises an administrator, or a public safety official, or both.

The asset tracking tag 214a, 214b is affixed to the asset 212, which can include a personal item, or an item with a tracking tag manufactured, sewn or printed onto that item for tracking purposes. In alternative embodiments, the asset may include a human being, an animal, and a plant. The tracking tag, which may include radio frequency or GS technology, or other radio, laser, Wi-Fi, VOIP, and other signals used for communication known in the art, communicates with the gateway which transmits the user's information to the database where the information is synthesized. As discussed below, aggregate data gathered by the tracking tag is fed back to the user 202, administrator, and authorized users to meet a variety of needs. In alternative embodiments, the asset is tracked without a tag. Rather, the asset is tracked from output signals generated by the asset, and detected for analysis, often with artificial intelligence.

As FIG. 2 shows, the user 202 can affix a tracking tag 214a-b to a vehicle, including but not limited to a car, motorcycle, bicycle, and scooter to determine where that vehicle is on their accompanying application. Users can add parking as a point on their route or the application may suggest available spaces as they are in transit and be guided to the closest spot to park according to their destination and availability of parking spots.

If there are public transportation options available within the service area 208 but not limited to the service area 208, tracking tags 214a-b are affixed to them in order to allow users to see their current location in near real-time, if the designated vehicle is full and know how long the wait should be. If this is the user's designated mode of transportation, the user's travel time will be updated according to this data.

The user 202 can affix tracking tags 214a-b to personal items including but not limited to laptops, cell phones, tablets, bags and other items they deem valuable and appropriate to track within the application. They can turn on alerts, so they are notified if an item is moved and see, within the service area 208, where the item is, how it is moving in near real-time and alert the authorities, or public safety officials 206 if needed, to its exact location and, if applicable, last known location before leaving the service area 208, using the application. They can also set timers for when items are allowed to move and approve movements including but not limited to distance, within certain geospatial locations, within or outside a building, during certain times, or maintaining certain proximity to other items.

Similarly, the administrator 204 can affix tracking tags 214a-b to any item they deem valuable or needed to track in order to track inventory tracking as well as mitigating theft and loss. Administrators 204 can turn on alerts, so they are notified if an item is moved and see, within the service area 208, where the item is, how it is moving in near real-time and alert the authorities if needed, to its exact location and, if applicable, its last known location before leaving the service area, using the application.

Looking again at FIG. 1, the method 100 also includes a Step 104 of tracking, through the location determining component, the at least one position of the asset in a service area, the service area being confined inside a geofence. In alternative embodiments, the method 100 also includes a step of communicating, by the communications element of the tracking tag, with a gateway. The communications element of the tracking tag transmits the position of the user to the data storage unit through the gateway.

The method 100 may further comprise a Step 106 of generating aggregate data from the asset, the aggregate data being based on the at least one position of the asset. The method 100 may include a step of storing the aggregate data in a data storage unit, which may include, a remote database, server, cloud, and a USB storage device. The aggregate data collected through the application, using the tracking tags 214a-b and any related components of operation that process, synthesize and analyze the collected data, may be used to properly address needs, wants, and concerns of users and administrators 204, both during and after incidents as well as patterns of human movement and behavior. Administrators 204 and stakeholders, using the aggregate data, may be able to make informed decisions for the future improvement of the service area 208.

The user 202 can view if a specified section of the service area 208 has heavy traffic based on the tracking tag 214a-b, which allow for the tracking of human movement. This will designate wait times for different activities within the service area 208 according to the current average speed and number of individuals, as well as continue to train the artificial intelligence software 220 to remember when certain areas are busy, which will Aid with smoother, quicker navigation routes.

In some embodiments, a Step 108 comprises synthesizing the aggregate data with an artificial intelligence software 220. In one embodiment, the artificial intelligence software 220 is operable with an app, or a smart device network that works in conjunction with the artificial intelligence software 220. The application can be useful for allowing predictive policing. Further, the artificial intelligence software 220 is trained to detect anomalies in human patterns of behavior and movement, both individually and collectively. Additional “learning” means by the artificial intelligence software 220 is described below.

A Step 110 includes learning, by the artificial intelligence software, a behavioral movement pattern of the asset based on the at least one position of the asset. In one possible embodiment, the artificial intelligence software 220 learns through “reasoning” to perform a search. For example, logical proof can be viewed as searching for a path that leads to a conclusion, where each step is the application of an inference rule.

In other embodiments, the artificial intelligence software 220 is based on different variations of logic. A first logic is propositional logic that involves truth functions, such as “or” and “not”. A second type of logic includes first-order logic that adds quantifiers and predicates, and can express facts about objects, their properties, and their relationship with each other. A third type of logic that may be utilized with the artificial intelligence software 220 is fuzzy logic that assigns a “degree of truth” (between 0 and 1) to vague statements, such as “Bob is fat” that are too linguistically imprecise to be completely true or false. However, in other embodiments, additional artificial intelligence means known in the art may be used to synthesize the aggregate data of the positions of the asset.

In some embodiments, the behavioral movement pattern includes a velocity, a direction, a turning radius, a pause in movement, and other trajectories and vectors that indicate a repeating or preferred movement or articulation by the asset and/or the user. For example, the asset can move proximally to the geofence at a first period of time, and then distally from the geofence at a second period of time. The tracking tag monitors the positions, accordingly.

a Step 112 may include prompting, by the artificial intelligence software, the user to navigate through the service area to access the asset, the prompting based on the synthesized aggregate data. In some embodiments, the step of prompting the user to navigate through the service area, based on the synthesized aggregate data, further comprises alerting the user to a threat in the service area. The threat could be a man-made threat, or a natural disaster. However, there are myriad reasons why the artificial intelligence software would prompt the user to navigate a navigational pathway. In one non-limiting embodiment, the used navigates an illuminated navigation path, through the service area based on the prompting by the artificial intelligence software. A step also involves detecting phone messages, which may be initiated by the artificial intelligence software. In one non-limiting embodiment, the user can receive a phone call or text message from a cellular phone.

A Step 114 comprises navigating, by the user, through the service area, the navigation based on the prompting by the artificial intelligence software. The user may navigate the service area by walking, riding a vehicle, or virtually through video communications. In one possible embodiment, the method 100 includes a step of navigating an illuminated navigation path, by the user, through the service area, the navigation based on the prompting by the artificial intelligence software. Also, the navigational decision is based on the weather, traffic, accommodations, near real-time incidents.

In some embodiments, the user 202 can be prompted to navigate to any room, on any floor, in any building in the service area. This can be navigated with real-time directions from the artificial intelligence software, according to user's average travel speed and requested accommodations. In this manner, the user 202 can follow routes with no stairs, fastest route, the shortest point from A to B, most convenient. The user 202 can also navigate inside and outside of buildings within the service area 208. In some embodiments, the user 202 can also choose to be guided on lit pathways after dusk.

Within the service area 208, there are predetermined points that can be entered into the application by the user 202 through typing or voice command. This serves to populate the location and prompt the user 202 whether they want to navigate to that location. This can be in any room, on any floor, in any building within the service area 208. The user 202 can see how long it will take to get to their destination using, but not limited to, their average travel speed, traffic, weather, accommodations they may need, and incidents within the service area 208.

Further, the artificial intelligence software has an app that allows the user 202 and/or the administrator 204 to track the asset's location within the service area 208. The user 202 can add connections and share their specific location with their designated and approved connections. The user 202 can share their current location, have a connection track their movements continuously and pinpoint a location where they want to meet someone and navigate to that location while sharing their movement and seeing the movement of their connection. The user 202 can message their connections, schedule meetings, and create emergency contacts.

For specified situations, the user 202 can check-in to a location within the service area 208. Using geospatial data in conjunction with the smart device system to monitor the proximity of the user 202 to the check-in location. As described below, at least one event can be triggered with the user's smart device, such as but not limited to airplane mode, certain applications on their device disabled or certain features of the application enabled as long as they are within a certain proximity or within a geofence 210 of the specified check-in area.

For certain activities within the service area 208 and possibly within a geofence 210 area within the service area 208, users can connect with authorized users that have special permissions within the application to offer feedback 216 and communicate. This can happen in the form of, but not limited to, asking the user 202 a multiple-choice question, asking the user 202 a question for written feedback 216, and back and forth messaging. Answered user 202 questions can be synthesized by the artificial intelligence software 220 and the aggregate data used to monitor feedback 216 and help administrators 204 and authorized users with special permissions to improve user 202 knowledge and user experience.

In some embodiments, the application is available in various forms for all matter of smart devices including but not limited to computers, smartphones, smartwatches, tablets, and smart screens in and around the service area 208. The pairing of headphones or a smart device with voice command enabled will allow the user 202 to operate hands-free for the features listed above. This allows the user to have easy accessibility to instructions and feedback from administrator 204 and public safety official 206.

The method 100 may further comprise a Step 116 of assigning at least one event, the event being indicative of the behavioral movement pattern of the asset. In one embodiment, the user, including the administrator, assigns or defines the event. The event is monitored and alerted to, based on the behavioral movement patterns. The user may then act accordingly to the type of event, as described below. For example, a final Step 118 includes relaying an alert to the user during the event. The alert may include an audible or visual alert transmitted from a personal communication device, such as a smart phone, for example.

The method 100 is unique in that it allows the user to provide feedback, a report, and other shared information may be dispersed about the event by the administrator or the public safety official. This helps describe why the event occurred, and ways to repeat or prevent similar events by the asset. For example, the method 100 allows for sharing, by the user, the position and the behavioral movement pattern of the asset in the service area. The method 100 also includes a step of generating feedback by the user, the feedback related to the position of the asset in the service area, and the behavioral movement pattern of the asset.

In one exemplary use, the user 202 and administrator 204 can approve movements by the asset according to: distance, within certain geospatial locations, within or outside a building, during certain times, or maintaining certain proximity to other items or any combination of the above listed. For example, if an item is moved from a designated area, the proper person or persons will be alerted whether admin or safety/security. Also, if user is within an area that should be closed at a certain time, the safety/security team will be notified and dispatched. This selective permission further enhances the present invention.

In another embodiment, the method 100 also includes a step of investigating, by the public safety official, the alerted event, whereby the location of the administrator in the service area is viewable by the public safety official. If the user 202 is designated as unsafe during an incident, the public safety official 206 is notified as to their status and/or the extent of their injuries, and, if necessary, have the proper number of paramedics and ambulances on the scene of the incident quickly. Users will be prompted to allow video and audio recording of the incident for evidence and to help those responding to the incident know more about the situation so they can be effective as they arrive at the incident location and direct users within, throughout and the surrounding incident area and around the surrounding incident area or areas. This will be real time video and audio. They can also turn off the recording at any time or elect to opt out of it.

The public safety official 206 is provided with end-to-end visibility of the service area 208 with the ability to see all user 202 in motion through the service area 208. The anomalous event is detected by default using artificial intelligence software 220, and interactive smart cameras. Though smart cameras are not definitely required, even if optimally that is preferred. This gives the public safety user 202 the ability to immediately deploy the closest available officers while giving them the necessary information from users at the incident to respond effectively and safely.

Further, when an incident is noted, the system records all data related to the incident including user 202 movement, messages with safety official 206, and audio and video recordings which can be used for further investigation and bring resolution to the incident. The aggregate data may be used to train the artificial intelligence software 220 on different types of events further, human responses and movement for different types of events, and movement and response times from safety official 206.

Specific authorized users within the service area 208 that are not part of public safety will have access to protocols within their application for review for specific incident types that they may encounter within the service area 208 so they may be prepared and work in conjunction with, but not limited to, public safety and other officials. They should also be prompted with instructions should incidents with predesignated protocols be triggered. In this manner, Authorized users will have more information at their disposal for incidents when possible.

In the event that the anomalous event does occur, the administrator 204 utilizes predetermined protocols along with authorized user 202—only alerts and instructions sent by administrators 204 and public safety official 206. Administrator 204 sends specific alerts prepared for a variety of incidents and events which can be quickly deployed as an event occurs. These can be easily updated and changed within the application. These alerts may be color-coded based on priority and data organization needs.

Yet another potential step may include filing a report about the event with the administrator or the public safety official. The report helps elucidate the event and consequences thereof. In the event of an emergency, the user 202 can navigate to a designated safety location within the service area 208, a designated health center within the service area 208 or request assistance to their exact location within the service area 208. For those without a smart device, a button may be provided. Emergency contacts are notified if assistance is requested. The user 202 can use voice control, long press or navigate to the section on the application where they can request assistance. If a user 202 is marked unsafe within the network, safety services will immediately be notified of their location and contact be made to the user 202.

If the user 202 is unable to speak or hear due to the incident or was previously unable due to outside circumstances, contact will be conducted through text on the application. Users can designate whether they are visually or hearing impaired when they set up their account in the application. For users in need of additional assistance, they can designate another user 202 as an aid. The user 202 designated as an Aid will have access to the original user's calendar 222. The original user 202 may elect to add other permissions for the emergency aid.

If a user 202 is missing, public safety official 206 can view the user's last known location within the service area 208, and the public safety official 206 can turn on alerts if they return to the service area 208. Public safety official 206 can also see, within the service area 208, where the user 202 is when they return, and their near real-time movements. Based on certain data, but not limited to user 202 patterns, schedules or predetermined appointments created within the application, the smart device system will note if the user 202 arrived.

Furthermore, if a certain threshold of absence within the service area 208, missed meetings or other specified event types occurs, wherein the user 202 was expected to be present within a service area 208, but did not arrive as expected, the anomaly will be noted. The user 202 can receive a message within the application, if they are using a smart device, checking if they are safe. The public safety official 206 may also be prompted to check in on the individual if the situation warrants.

Another unique event that is created by the user 202 is a travel event. Thus, the method comprises a step of marking the travel event on a calendar. In one non-limiting embodiment, the event comprises a travel event. Furthermore, the method can include a step of triggering the alert to indicate the travel event to the user. Consequently, the method may include a step of navigating, by the user, the service area to reach the travel event, whereby the synthesized aggregate data generates an optimal route to the travel event. The user 202 can also add the travel event to a personal calendar 222 within the application. Furthermore, the user 202 can add the specific location of where the travel event is taking place. In alternative embodiments, users may record on command the position of the asset while travelling, while making movement, and all other significant incidents.

In some embodiments, the method 100 may comprise an additional step of triggering an alarm to remind the user 202 about the travel event. When the time for the event is near, the user 202 can be prompted that it is time to leave or they can leave for their destination at their own leisure. However, within the calendar 222, the user 202 can view the duration of time necessary to arrive at the destination by using: their average travel speed, traffic, weather, accommodations, and incidents within the service area 208.

In yet other embodiments, the user 202 can click an event in their calendar 222 and begin navigation to their destination within the service area 208 in lieu of searching for an address in the application map. The users 202, 204, 206 can also add connections to the travel event in the calendar 222 and edit location sharing permissions to meet somewhere specific or have someone meet them where they are currently located. Users can reserve specific locations for allotted amounts of time and can search available locations based on specific criteria. Some authorized users may be stored in a database 218 for the user 202 of the application to message, schedule appointments with or meet at a specific location.

In some embodiments, the user can create events that control the position and behavioral movement pattern of the asset. Thus, the method comprises a step of creating, by the user, at least one condition for the asset to navigate the service area, the condition being based on at least one of the following: the position of the asset in the service area, the behavioral movement pattern of the asset, a time period, and a distance between the asset and the user.

In one exemplary use of the method, the tracking tags 214a, 214b are utilized to gather data about athletes' performance and help those athletes/teams gain a competitive advantage over their competition or improve their training. The user can add a tracking tag to active wear, including but not limited to shoes, socks, shirts, shorts, pants, hats, and swimwear to determine how the athlete moves but is not limited to on the court, in the gym and pool, etc. The tracking tags 214a-b can be used to track height, speed, location, form, how the player interacts with other teammates/users.

Then method 100 is unique in that additional sports equipment with attached tracking tags 214a-b can be used to determine how the equipment moves on the court, gym, pool, etc. including but not limited to height, speed, location, form, how to the player interacts with other teammates/users. The sports equipment could include but is not limited to balls, bats, clubs, rackets, paddles, archery equipment, etc.

This allows users 202, 204, 206 to gain sport-specific insights into a strategy for each athlete and team-wide; Show problem areas that coaches can target in training; Track athletes' movements; Analytics for each athlete; allow the AI to recognize how athletes are moving within formation vs. opponents, find weaknesses in positioning, formation; Recommends optimal strategies against certain formations; Set performance goals; Save real-time formations that were successful for study; and Track what movements cause specific injuries to mitigate losses to the team and protect athletes.

In conclusion, the method enables a user, e.g. administrator, public safety official, to effectively track and analyze the position and behavioral movement pattern of at least one asset in a service area, which is itself confined in a geofence. A tracking tag detects and communicates the position of the asset in the service area. An artificial intelligence software analyzes the locations of the asset to generate aggregate data representing the locations of the asset; and then synthesizes the data to create a behavioral movement pattern of the asset.

Further, the artificial intelligence software prompts the user to navigate the service area to access the asset, or an area related to the asset. The user sets up an event indicative of the behavioral movement pattern of the asset. An alert transmits to user when the event occurs. For example, a movement pattern indicative of an emergency situation alerts an administrator or public safety official to investigate. The method is unique in that it allows the user to provide feedback, a report, and other shared information may be dispersed about the event by the administrator or the public safety official. This helps describe why the event occurred, and ways to repeat or prevent similar events by the asset. In this manner, the user can track and analyze the position and behavioral movement pattern of at least one asset in a service area through use of a tracking tag and artificial intelligence software.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method of intelligent tracking and analysis of assets, the method comprising:
affixing, by a user; a tracking tag to at least one asset, the tracking tag comprising a location determining component operable to track at least one position of the asset, the tracking tag further comprising a communications element coupled with the position determining component, the communications element operable to communicate the tracked position of the asset;
tracking, through the location determining component, the at least one position of the asset in a service area, the service area being confined inside a geofence;
generating aggregate data from the asset, the aggregate data being based on the at least one position of the asset;
synthesizing the aggregate data with an artificial intelligence software;
learning, by the artificial intelligence software, a behavioral movement pattern of the asset based on the at least one position of the asset;
prompting, by the artificial intelligence software, the user to navigate through the service area to access the asset, the prompting based on the synthesized aggregate data;
navigating, by the user, through the service area, the navigation based on the prompting by the artificial intelligence software;
assigning at least one event, the event being indicative of the behavioral movement pattern of the asset; and
relaying an alert to the user during the event.

2. The method of claim 1, wherein the user comprises an administrator, or a public safety official, or both.

3. The method of claim 1, further comprising storing the aggregate data in a data storage unit.

4. The method of claim 3, further comprising communicating, by the communications element of the tracking tag, with a gateway.

5. The method of claim 4, wherein the communications element of the tracking tag transmits the position of the user to the data storage unit through the gateway.

6. The method of claim 1, further comprising navigating an illuminated navigation path, by the user, through the service area, the navigation based on the prompting by the artificial intelligence software.

7. The method of claim 1, wherein the asset includes at least one of the following: a car, a bus, a truck, a forklift, a motorcycle, a bicycle, a scooter, a person, and an animal.

8. The method of claim 1, further comprising assigning, by the user, an event to the behavioral movement pattern of the asset.

9. The method of claim 1, wherein the step of prompting the user to navigate through the service area, based on the synthesized aggregate data, further comprises alerting the user to a threat in the service area.

10. The method of claim 2, further comprising a step of filing a report about the event with the administrator, the public safety official, or both.

11. The method of claim 1, wherein the event comprises a travel event.

12. The method of claim 11, further comprising marking the travel event on a calendar.

13. The method of claim 12, further comprising triggering the alert to indicate the travel event to the user.

14. The method of claim 13, further comprising navigating, by the user, the service area to reach the travel event, whereby the synthesized aggregate data generates an optimal route to the travel event.

15. The method of claim 1, further comprising creating, by the user, at least one condition for the asset to navigate the service area, the condition being based on at least one of the following: the position of the asset in the service area, the behavioral movement pattern of the asset, a time period, and a distance between the asset and the user.

16. The method of claim 1, further comprising sharing, by the user, the position and the behavioral movement pattern of the asset in the service area.

17. The method of claim 1, further comprising generating feedback by the user, the feedback related to the position of the asset in the service area, and the behavioral movement pattern of the asset.

18. The method of claim 2, further comprising investigating, by the public safety official, the alerted event, whereby the location of the administrator in the service area is viewable by the public safety official.

19. A method of intelligent tracking and analysis of assets, the method comprising:
affixing, by an administrator, a tracking tag to at least one asset, the tracking tag comprising a location determining component operable to track at least one position of the asset, the tracking tag further comprising a communications element coupled with the position determining component, the communications element operable to communicate the tracked position of the asset;
tracking, through the location determining component, the at least one position of the asset in a service area, the service area being confined inside a geofence;
generating aggregate data from the asset, the aggregate data being based on the at least one position of the asset;
storing the aggregate data in a data storage unit,
synthesizing the aggregate data with an artificial intelligence software;
learning, by the artificial intelligence software, the movement and behavior of the asset;
prompting the administrator to navigate through the service area, based on the synthesized aggregate data;
detecting a phone message initiated by the;
navigating, by the administrator, through the service area, the navigation being based on reaching a location in the service area, the navigation further being based on the movement, position, and a general behavioral pattern of the asset;
sharing, by the administrator, the position or the movement of the asset in the service area;
creating, by the administrator, at least one condition for the asset to navigate the service area, the condition being based on at least one of the following: a geospatial location in the designated area, a time period, and a proximal distance between the asset and the administrator;
generating, by the administrator, feedback, the feedback related to the movement, position, and general behavioral patterns of the administrator and the asset;
assigning at least one event related to the movement, position, and general behavioral pattern of the asset and the administrator in the service area;
relaying an alert to the administrator, the public safety official, or both, when the event occurs;
investigating, by a public safety official, the alerted event, whereby the location of the administrator in the service area is viewable by the public safety official;
generating on a calendar, by the administrator, a travel event;
triggering the alert to remind the administrator about the travel event; and
navigating, by the administrator, the service area to reach the travel event, whereby the synthesized aggregate data generates an optimal route to the travel event.

20. A method of intelligent tracking and analysis of assets, the method comprising:
emitting by an asset, a unique output signal, the output signal comprising a location operable to track at least one position of the asset;
identifying the output signal for the asset,
tracking, through the output signal, the at least one position of the asset in a service area, the service area being confined inside a geofence;
generating aggregate data from the asset, the aggregate data being based on the at least one position of the asset;
synthesizing the aggregate data with an artificial intelligence software;
learning, by the artificial intelligence software, a behavioral movement pattern of the asset based on the at least one position of the asset;
prompting, by the artificial intelligence software, the user to navigate through the service area to access the asset, the prompting based on the synthesized aggregate data;
navigating, by the user, through the service area, the navigation based on the prompting by the artificial intelligence software;
assigning at least one event, the event being indicative of the behavioral movement pattern of the asset; and
relaying an alert to the user during the event.
